(19) United States
(12) Patent Application Publication
(10) Pub. No.: US 2019/0065442 A1
(43) Pub. Date: Feb. 28, 2019

(54) SNAPPING CONTENT HEADER IN SCROLLED DOCUMENT

(71) Applicant: SAP SE, Walldorf (DE)

(72) Inventors: Roman Rommel, Neustadt an der Weinstrasse (DE); Carolin Seel, Heidelberg (DE); Denis Timur, Neidenstein (DE); Georg Christoph, Karlsruhe (DE); Melanie Siegmann, Heidelberg (DE); Janos Varadi, Ludwigshafen (DE); Annette Jann, Heidelberg (DE)

(21) Appl. No.: 15/691,188

(22) Filed: Aug. 30, 2017

(51) Int. Cl. G06F 17/21; G06F 3/0485; G06F 3/0483

(52) U.S. Cl. CPC G06F 17/217; G06F 3/0483; G06F 3/0485

(57) ABSTRACT

A system includes a processor that executes instructions stored in a memory to create a rendering engine that renders a document in a scroll container in a user interface (UI) on a computing device. The document contains one or more content header components associated with respective document contents and is scrollable through the scroll container. At least one content header component is scrolled out of view in the scroll container when a first portion of the document is scrolled out of the scroll container bringing a second portion of the rendered document in view in the scroll container after scrolling. In response, the rendering engine snaps the one content header component that has been scrolled out of view back into the scroll container so that the one content header component is in view along with second portion of the rendered document that is in view in the UI after scrolling.

### TECHNICAL FIELD

This description generally relates to user-computer interfaces and user experiences. The description, in particular, relates to systems and techniques for providing a user experience in viewing data and information related to one or more software applications on a computing device.

### BACKGROUND

Computer applications (e.g., business applications, scientific applications, web applications, etc.) can display large data objects in text or graphics on a computer display, window, or viewport (“computer screen”) of a computing device. A data object (e.g., a table, a spreadsheet, a news item, a report, etc.) can have a full display size that is larger than a size of the computer screen of the computing device so that only a portion of the data object is visible on the computer screen at a given time. The remainder portions of the data object can remain invisible to a viewer at the given time. To navigate to the remainder portions of the data object, the viewer may use traditional “scrolling” techniques (e.g., using scroll bars, page up or page down buttons, etc.) to move the data object on the computer screen up, down, or sideways, with new information appearing as the old information disappears from view.

A problem with the traditional scrolling techniques in navigating from a view of a first portion of the data object content to a view of a second portion of the data object content on the computer screen is that the user can loose the focus and context of the second portion of the data object content. For example, when the displayed data object is row-column table, the displayed first portion of the table may include a table header (e.g., column header) listing names of columns of the table. Scrolling to the second portion of the table may result in the table header being moved out of view on the computer screen. Thus, the viewer may not be able to visually reference the column header names for the rows and columns in the displayed view of the second portion of the table.

Consideration is now given to user experience in interacting with displays of a large data object that can be viewed only small portion-by-small portion on a computer screen.

### SUMMARY

A system includes a processor and a memory. In a general aspect, the processor executes instructions stored in the memory to create a rendering engine. The rendering engine renders a document as a page in a scroll container in a user interface (UI) on a computing device. The document contains one or more content header components associated with respective document contents. The rendered document page is scrollable through the scroll container. In operation, at least one content header component can be scrolled out of view in the scroll container when a first portion of the document is scrolled out of the scroll container bringing a second portion of the rendered document in view in the scroll container after scrolling. The rendering engine snaps the one content header component that has been scrolled out of view back into the scroll container so that the one content header component is in view along with second portion of the rendered document that is in view in the UI after scrolling.

The details of one or more implementations are set forth in the accompanying drawings and the description below. Further features of the disclosed subject matter, its nature and various advantages will be more apparent from the accompanying drawings, the following detailed description, and the appended claims.

### BRIEF DESCRIPTION OF THE DRAWINGS

The accompanying drawings, in which like numerals indicate like components, illustrate embodiments of the disclosed subject matter.

FIG. 1 is a schematic block diagram showing an example computer application system, in accordance with the principles of the present disclosure.

FIG. 2 is a schematic diagram showing an example data object/page, which for example includes multi-sectioned content that is organized under UI elements (i.e., content separators), in accordance with the principles of the present disclosure.

FIG. 3 is a schematic illustration of an example display of the data object/page (of FIG. 2) in which only a first portion of the data object/page can be fit and is rendered for view in a display window, in accordance with the principles of the present disclosure.

FIG. 4 is a schematic illustration of the display window (of FIG. 3) in which the first portion of the data object/page is moved up out of the display window by scrolling action to bring a second portion of the data object/page into view in the display window, in accordance with the principles of the present disclosure.

FIG. 5 is a schematic illustration of the display window (of FIG. 4) in which a rendering engine has snapped a “snapping” content header component in to view in the display of the second portion of the data object/page in the display window, in accordance with the principles of the present disclosure.

FIG. 6 is a schematic illustration of the display window of FIG. 5 in which all orphaned content has been scrolled out of view, and the rendering engine has released the associated snapping content header component the so that it is no longer in view in the display window, in accordance with the principles of the present disclosure.

FIG. 7 is a schematic illustration of an example in which two snappable content separators have been snapped into the display window (of FIG. 5) as guide to the orphaned content in view in the display window, in accordance with the principles of the present disclosure.

FIGS. 8A and 8B are screenshots of an example UI display window illustrating use of snapped-in content headers to guide viewers to orphaned document content in response to a viewer scrolling a document through the display window, in accordance with the principles of the present disclosure.

FIG. 9 is a screenshot of an example mobile device display screen that includes a summary line feature, in accordance with the principles of the present disclosure.

FIG. 10 is an illustration of an example method for rendering a data object (e.g. a document) in a user interface (UI) on a computing device, in accordance with the principles of the present disclosure.

FIG. 11 is a block diagram illustration of a rendering engine for displaying data objects on a user interface of a computing device, in accordance with the principles of the present disclosure.

### DETAILED DESCRIPTION

A user interface (UI) renderer enables “content” header snapping to provide reading context in a document (or other data object) rendered in a UI container (e.g., display window) of the computing device, in accordance with the principles of the present disclosure. The document may be so large that that only a portion of the content of the document is visible in the display window of the computing device at a given time, and a viewer may have to scroll through the document to bring other portions of the content of the document into view. The UI renderer can snap (or stick) a top level “content” header into the rendered document in the display window to provide context to the scrolled document content that is being presently displayed in the display window of the computing device. The UI renderer can also snap one or more lower level sub content header elements to provide context to the scrolled document content that is being presently displayed in the display window of the computing device. This feature of the UI renderer can provide a viewer with a viewing experience that is intuitive and not jarring when scrolling through a document that has, for example, multiple hierarchical levels of document content.

A document author may choose or select which portions or components of the document are snappable and which portions or components are not snappable. In example implementations, portions or components of the document that are not snappable can be scrolled through the display window of the computing device without content header snapping. In the example implementations, portions or components of the document that are snappable may have a content header snapped in, for example, when the portions or components are scrolled to the top of the display window of the computing device. This snapping experience can be extended over multiple columns or sections in cases where the document has multiple columns or sections. The snapping experience can also be extended over multiple columns or sections in the document where different columns or sections in the document have different snappable and non-snappable content headers.

The UI renderer may, for example, based on a standard Dynamic Page class implementation in which the document is displayed as a Dynamic Page on the UI. The UI renderer may be constructed by a “Snap-enabled” Dynamic Page implementation that is obtained by sub classing the standard Dynamic Page class implementation, in accordance with the principles of the present disclosure. A Dynamic Page can have multiple components. Each component contained in the Dynamic Page may be a “snappable” component, or alternatively, a “not snappable” component. The Snap-enabled Dynamic Page implementation enables all components contained in the Dynamic Page that declare themselves as snappable to be snapped by the UI renderer to the right geometry in the UI display.

From another perspective, a computer application may have a front end, which visually displays the content of a data object (e.g., a table, a report, a document, etc.) as a page (e.g., a dynamic page) on a user interface (UI) (e.g., a display screen) of a computing device (e.g., a desktop computer, a laptop computer, a smart phone, a mobile phone, etc.). A displayed page may be displayed on the UI, for example, with a page header (e.g., a page title) adjoining a content area. The page header may have snapping (or sticking) characteristics such that the page header is always visible (e.g., on the top or a side of the page) whenever the page is displayed on the UI. The page's displayed content area may be displayed, for example, below the page header that is displayed on the top of the page.

One or more content separators (e.g., toolbars, section headers, section sub-headers, or ribbons, etc.) (collectively “content headers”) may be included in the displayed content area of the page. These content headers may include informational UI control elements and actionable UI control elements. An actionable UI control element may, for example, be a navigation links container that includes actionable links or tabs to help navigation within the page content (e.g., from one section of the page content to another section of the page content). A content header of a displayed data object may, for example, include one or more of a title with actions, a toolbar, a filter bar, a search bar in lists, a shell bar, notifications, navigation controls (e.g., breadcrumb, multi instance, section links or tabs), and other optional information on a page (e.g., dynamic/object page).

For convenience in description, the terms “content header,” “content header component,” and “content separator” may be used interchangeably herein. Further, the terms “UI” and “display window” may be used interchangeably herein. Further, the “data object” being displayed may be interchangeably referred to as the “page” herein.

In traditional displays, the content header of the displayed data object is attached to a first portion of the data object content. The content header is visible on the computer screen only when the first portion of the data object content is visible on the computer screen. When the first portion of the displayed data object content is scrolled out of view (e.g., by a viewer wanting to view other portions of the data object content), the content header attached to the first portion is also moved out of view and may not be viewable by, or accessible to, the viewer. For example, in a case where the data object content is multi-sectioned content, the displayed first portion data object may include a section navigation links container, which includes links that can be used to navigate to the different sections of the data object content. Back and forth navigation between the different sections may not be possible because the section navigation links container may be scrolled out of view and not accessible when the viewer is viewing another portion of the data object that is not adjacent to the section navigation links container.

This disclosure is directed to the behavior, properties and characteristics of objects (e.g., tables or sections) inside the page content. In particular, this disclosure describes the “snapping” behavior, properties and characteristics of parts of these objects (headers, toolbars, column headers, etc.) (hereinafter “snapping” “content header components”). A snapping content header component may snap into place at a target location in the displayed content area of the page so that it (i.e. the snapping content header component) is visible in the displayed content area of the page on the UI (e.g., like the page header that is visible adjoining the content area) when the data object content is scrolled in the UI, in accordance with the principles of the present disclosure.

More than one snapping content header components may snap into place at respective target locations in the displayed content area as the data object content is scrolled in the UI. The snapping content header components may, for example, correspond to a hierarchy of content separators (e.g., section header, a first level section sub header, a second level section sub header, etc.).

In example implementations, a target location for a first snapping content header component may be an uppermost part of the page's displayed content area. A target location for a next snapping content header component may be just below the location of the lowest snapping content header component (e.g., the first snapping content header) that has been already snapped in place. One or more of the “snapped-in” content header components may be released (i.e., unsnapped or removed from view) from the respective target locations as the data object content is further being scrolled through the UI. A snapped-in content header component may be released, for example, when the snapped-in content header component is no longer relevant to the scrolled content being displayed in the UI.

Each snapping content header component may have its own snap point (or snap time) and its own release point (or release time) relative to the scrolling action that moves the page content up or down through the UI.

A snap point for a snapping content header component may correspond to the point in the scrolling action at which the snapping content header component reaches the uppermost part of the page's displayed content area that is below any other snapping content header component that may be already snapped in view in the displayed page content in the UI. In other words, the target location for the snapping content header component on the UI may be just below the lowest snapped-in content header components presently in view in the displayed page content in the UI.

A release point for a snapped-in content header component may depend on the page content being displayed below the snapped-in content header component in the UI. A release point for the snapped-in content header component may correspond to the point in the scrolling action at which the snapped-in content header component is no longer relevant to the page content being displayed in the UI. For example, a snapped-in table header (of a displayed table) may have a release point in the scrolling action when the last row of the table reaches the lowest snapped-in content header component presently in view in the displayed page content in the UI, because the snapped-in table header is not relevant when no part of the table (e.g., rows) is on display in the UI. Similarly, for example, a snapped-in section header may have a release point corresponding to the point in the scrolling action when the section bottom reaches the lowest snapped-in content header component presently in view in displayed page content in the UI.

In other words, a snapped-in content section header may remain snapped-in as long as a part of its corresponding object (e.g., section content, sub section content, etc.) is visible in the UI. For example, a snapped-in content section header may be released when all of the section content is scrolled up out of the UI and is no longer visible in the UI. If the scrolling action is later reversed (e.g., to scroll the page down) the previously scrolled out section content may reappear in the UI. In such instance, the previously released content section header may be again snapped in the UI to be visible along with the reappearing section content visible in the UI.

From a perspective of the sizes or dimensions of objects displayed in the UI, a displayed snapping content header component may have a display height (or width) in the scrolling direction. In an example implementation, as the data object is scrolled up through the UI (e.g., by moving a scroll bar downward), a first snapping point for the snapping content header component may occur when the snapping content header component reaches the lowest snapped-in header component that may be already on display in the UI. A first release point for the snapping content header component may occur when the bottom of the corresponding content object (e.g., section content object) reaches the bottom of the snapped-in header component on display in the UI. If the data object is then reverse scrolled down through the UI (e.g., by moving a scroll bar upward), content corresponding to the previously released snapping content header component may reappear in the UI. A second snapping point for the snapping content header component may occur when the reappearing content reaches the first release point plus the display height (or width) of snapping content header component in the scrolling direction. Further, a second release point for the snapping content header component may occur when may occur when the top of the corresponding content object (e.g., section content object) being scrolled down reaches the bottom of the snapped-in header component on display in the UI. The released snapped-in content header component may thereafter scroll down together with the top of the corresponding content object (e.g., section content object) that is being scrolled down through the UI.

In some instances, a snapping content header component (e.g., a navigation links container) may be relevant to all subsequent content in the data object. Such a snapping content header component (e.g., a navigation links container) may, like any other snapping content header component, have a snapping point, but may not have a release point because the snapping content header component (e.g., the navigation links container) remains relevant to all subsequent content in the data object as the data object is scrolled through the UI.

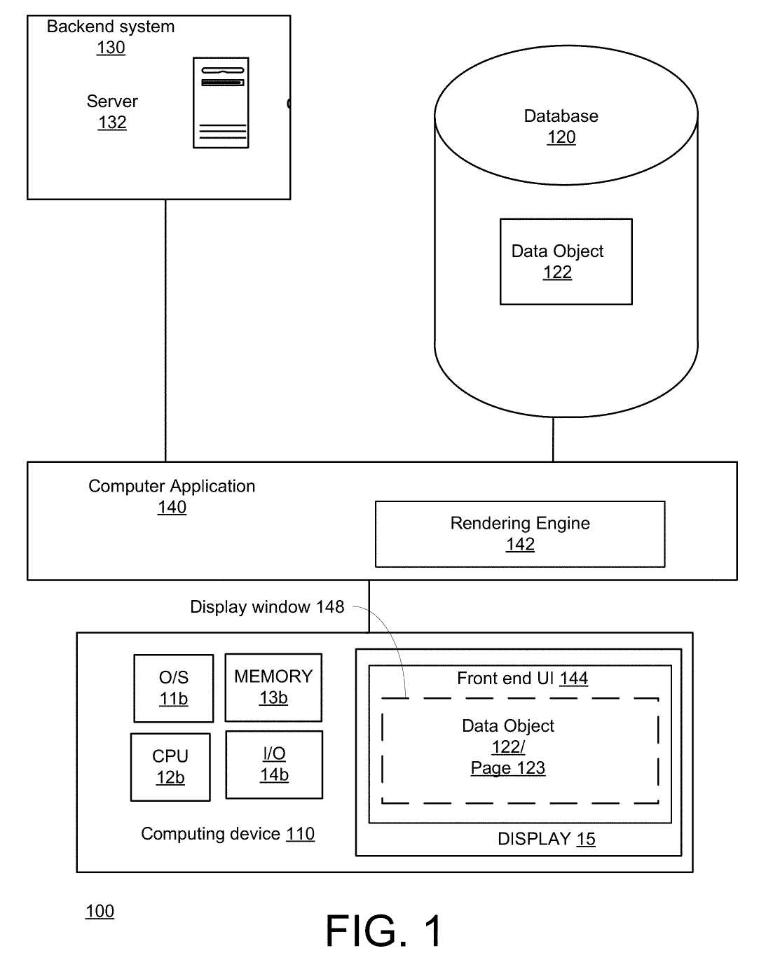

FIG. 1 is a schematic block diagram showing an example computer application system, in accordance with the principles of the present disclosure.

System 100 may include a computer application 140 coupled to a database 120. Computer application 140 may, for example, be hosted or launched on a computer 110. Computer 110, which includes an O/S 11b, a CPU 12b, a memory 13b, and I/O 14b, may further include a user interface (UI) or display 15. Computer 110, may include a rendering engine 142 which includes an O/S 11b, a CPU 12b, a memory 13b, and I/O 14b, may further include a user interface (UI) or display 15.

Although computer 110 is illustrated in the example of FIG. 1 as a single computer, it may be understood that computer 110 may represent two or more computers in communication with one another. Therefore, it will also be appreciated that any two or more components 120-140 of system 100 may similarly be executed using some or all of the two or more computers in communication with one another. Conversely, it also may be appreciated that various components illustrated as being external to computer 110 may actually be implemented therewith. In an example scenario, computer application 140 may be an application, which can run on computer 110 or, for example, in another computing environment (e.g., Backend system 130/Server 132).

Computer application 140 may generate or receive data (e.g., a data object 122) stored in database 120 and/or may consume the data stored in database 120. In an example implementation, computer application may data (e.g., a data object 122) on display 15.

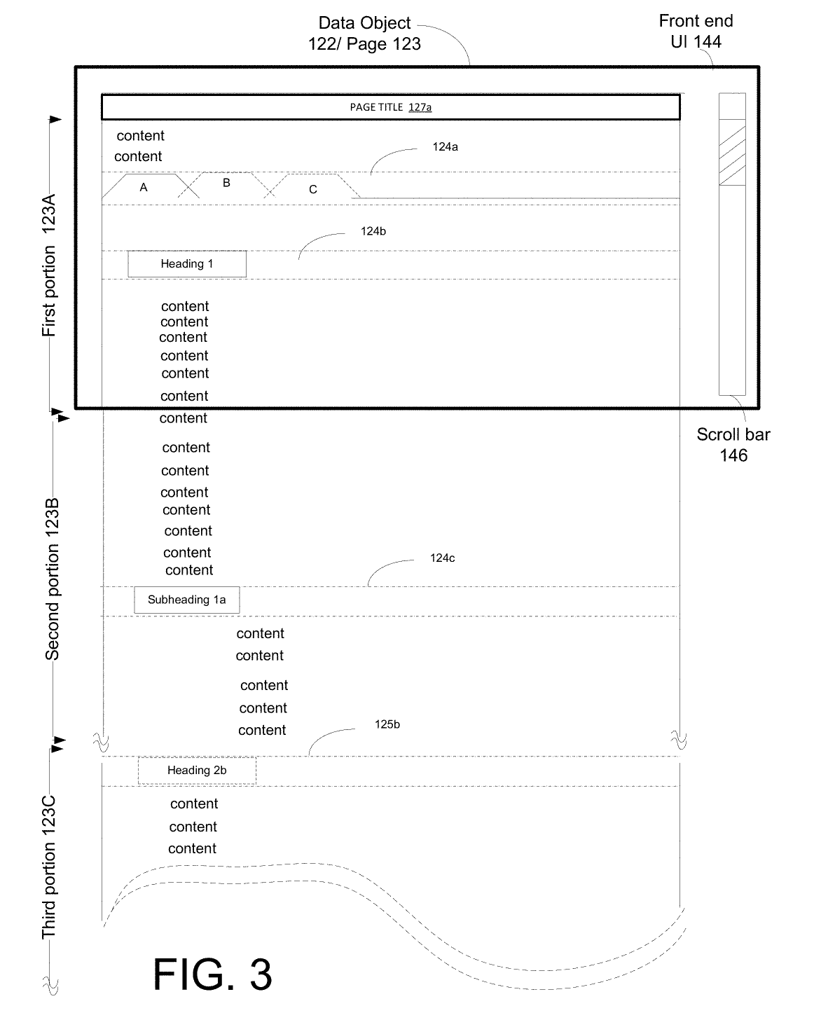

Rendering engine 142 (which may be included or coupled to computer application 140) may configured to display data object 122 or portions thereof in a display window 148 of an interactive frontend (e.g., front end UI 144) of the computer application. UI 144 may, for example, be constructed using standard components (e.g., generic user interface building blocks (UIBBs)) and/or custom-developed components for UI display entities (e.g., graphics, charts, lists, forms, trees, etc.), which can be used to display data. UI 144 may, for example, include a scroll bar 146 (FIG. 3) that can be user activated to scroll the displayed content of data object 122 up or down in a scroll container (e.g., display window 148) on UI 144. In an example implementation, data object 122 may be displayed, for example, as a page 123 in display window 148.

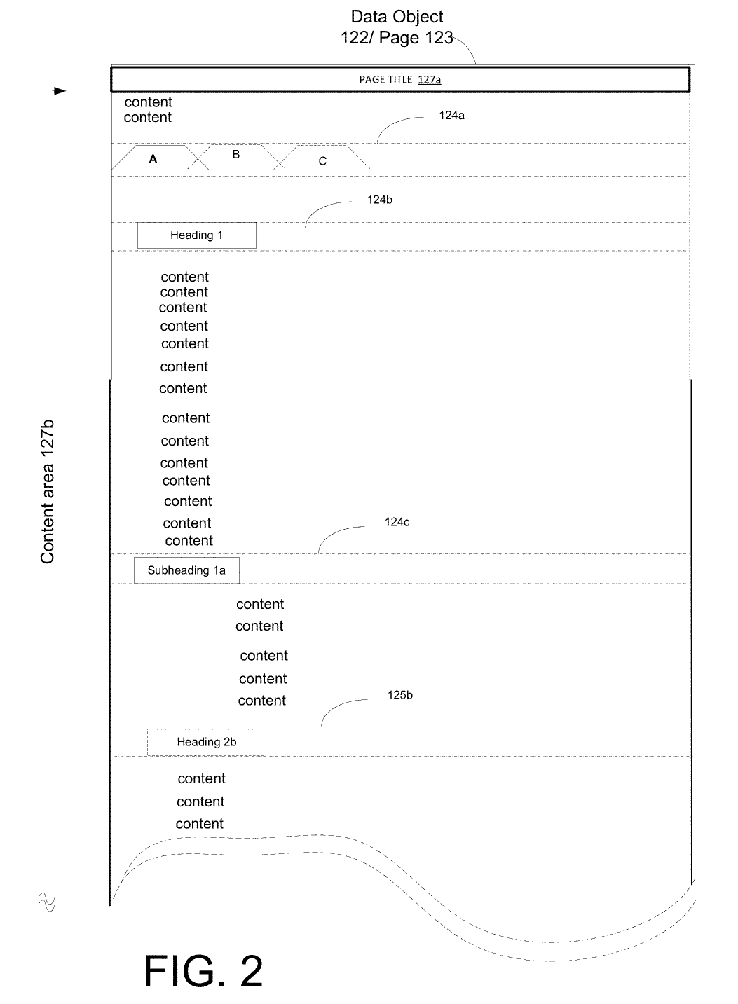

An example data object 122 may, for example, be a table, a document, a business report, etc. FIG. 2 shows an example data object 122/page 123, which for example includes multi-sectioned content objects in a content area 127b under page title 127a. Page title 123a may be configured to be snapped in place (e.g., at the top of page 123) by rendering engine 142 whenever page 123 is on display. The multi-sectioned content objects in content area 127b may be organized in content area 127b under UI elements (i.e., content separators) (e.g., navigation links container 124a, content header component 124b, and subheading component 124c, content header component 125b, etc.), in accordance with the principles of the present disclosure. The content separators (e.g., navigation links container 124a, content header component 124b, subheading component 124c, content header component 125b, etc.) may visually separate and guide a viewer to different data object 122 content on page 123.

One or more of content separators (e.g., navigation links container 124a, content header component 124b, and subheading component 124c, content header component 125b, etc.) may be configured or designated to be reusable by rendering engine 142, for display (e.g., as snapping content headers) at positions other than their original positions in data object 122/page 123.

Often data object 122/page 123 may include more content than can be fit and displayed at one time in display window 148 on UI 144. FIG. 3 schematically shows, for example, that only a portion of data object 122/page 123 (e.g., first portion 123A) can be fit and rendered for view in display window 148 on UI 144 at a given time, in accordance with the principles of the present disclosure. First portion 123A may, for example, include content under page title 123a, under navigation links container 124a, and some of the content under content header component 124b. Other portions of (e.g., second portion 123B, third portion 123C, etc.) of data object 122/page 123 may not be displayed in display window 148 on UI 144 at the given time. However, a viewer may be able to bring the undisplayed other portions (e.g., second portion 123B) into view using UI controls (e.g., using scroll bar 146, finger touch-screen scrolling, etc.) to scroll page 123, for example, up or down through display window 148 on UI 144.

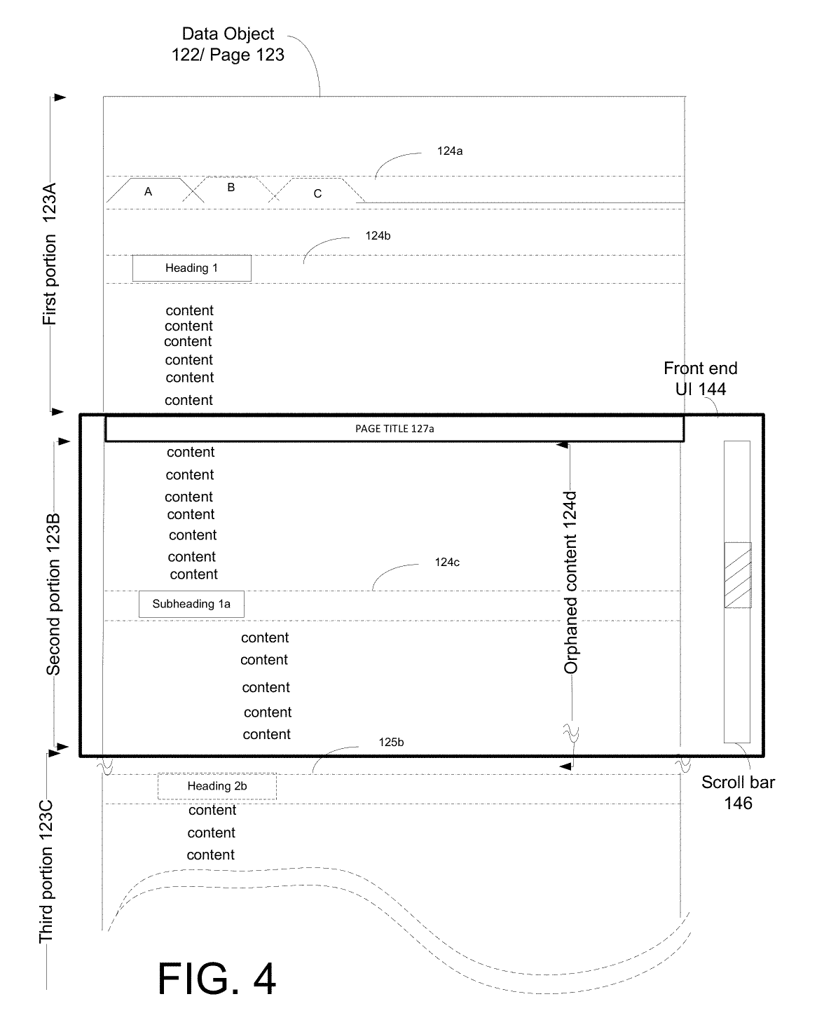

FIG. 4 schematically shows an example in which first portion 123A is moved up out of display window 148 by scrolling action (e.g., using scroll bar 146, or finger touch-screen scrolling) to bring second portion 123B in to view in display window 148. As the scrolling action brings second portion 123B in to view in display window 148 by moving first portion 123A up, content separators (e.g., navigation links container 124a, content header component 124b,) in first portion 123A are also moved out of view and are not available as a visual guide for the displayed content of second portion 123B. Actions in the now out-of-view content separators (e.g., navigation links in navigation links container 124a) are also not accessible to the viewer.

A content separator (e.g., content header component 124b) scrolled out of display window 148 may leave “orphaned” content (e.g., orphaned content 124d) in view in display window 148 for which the moved out content separator (e.g., content header component 124b) is not available to visually guide the viewer.

In the example implementations described herein, rendering engine 142 may be recognize an event of one or more content separators (e.g., navigation links container 124a, content header component 124b, and subheading component 124c, content header component 125b, etc.) in first portion 123A (or a currently displayed portion) being moved out of view from display window 148. Rendering engine 142 may recognize that a content separator scrolled out of view from display window 148 can have “orphaned” associated content (e.g., orphaned content 124d) that still remains in view in display window 148. However, the scrolled out content separator (e.g., content header component 124b) is not available to visually guide the viewer to the orphaned associated content that still remains in view in display window 148. If the content separator associated with the orphaned content has been designated as being snappable, rendering engine 142 may reintroduce the content separator (that has been moved out of view) back into the display as a visual guide to the orphaned content (e.g., orphaned content 124d) in view in display window 148.

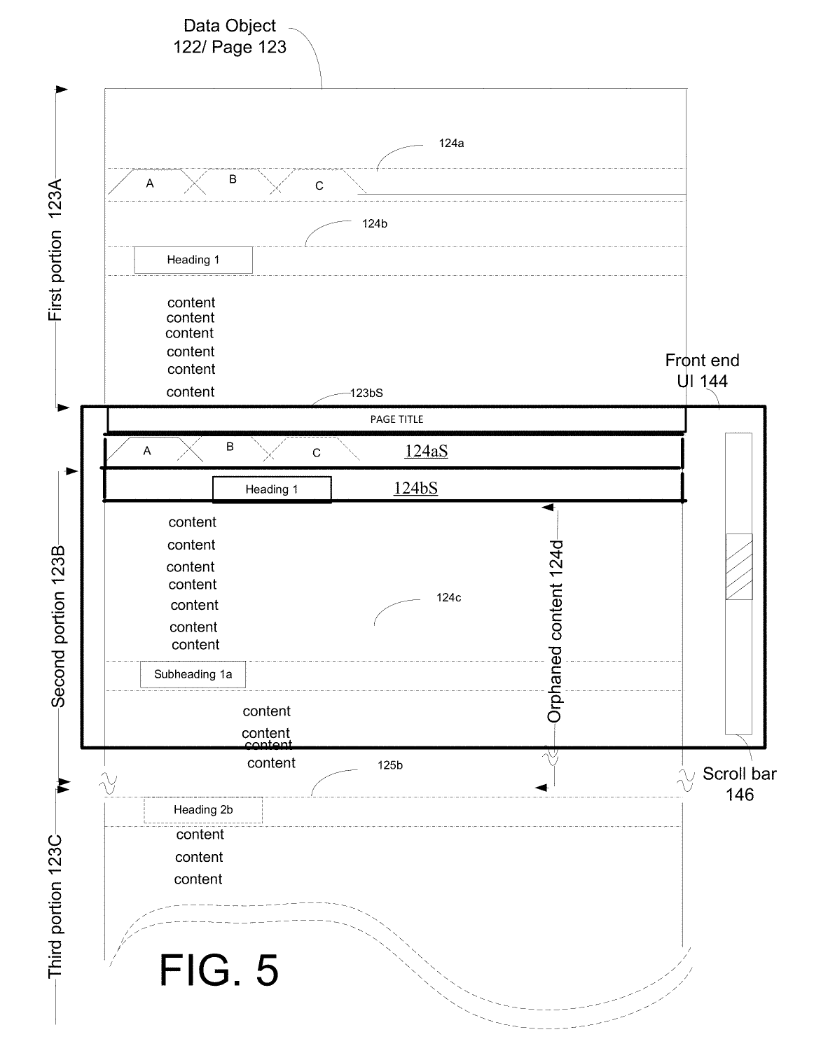

FIG. 5 schematically shows the example of FIG. 4 in which after first portion 123A including navigation links container 124a and content header 123b is moved up out of display window 148 (by scrolling action to bring second portion 123B in to view in display window 148) rendering engine 142 has reintroduced navigation links container 124a and content header 123b in the display of second portion 123B, for example, as snapped-in navigation links container 124aS and snapped-in content header component 124bS. Rendering engine 142 may, for example, snap snapped-in navigation links container 124aS to a target area that is just below page title 123a, and snap snapped-in content header component 124bS to a target area that is just below snapped-in navigation links container 124aS in display window 148 (as shown in FIG. 5) as guide to the orphaned content (e.g., orphaned content 124d) in view in display window 148.

Data object 122/page 123 may be further scrolled up (or down) through display window 148 on UI 144 by the viewer. Rendering engine 142 may leave the snapped-in header components (e.g., snapped-in navigation links container 124aS and snapped-in content header component 124bS snapped to the respective target areas in display window 148 (as shown in FIG. 5) as long as there is orphaned content (e.g., orphaned content 124d) in view in display window 148. When data object 122/page 123 has been scrolled up (or down) through display window 148 so that there is no orphaned content (e.g., orphaned content 124d) in view in display window 148, there is no need to display snapped-in content header component 124bS in display window 148 to guide a viewer. Accordingly, rendering engine 142 may unsnap (i.e., release) snapped-in content header component 124bS so that it is no longer in view in display window 148. Rendering engine 142 may leave snapped-in navigation links container 124aS in position at all times so that the viewer can navigate to different sections of page data object 122/page 123 even as different portions of page data object 122/page 123 are scrolled in display window 148.

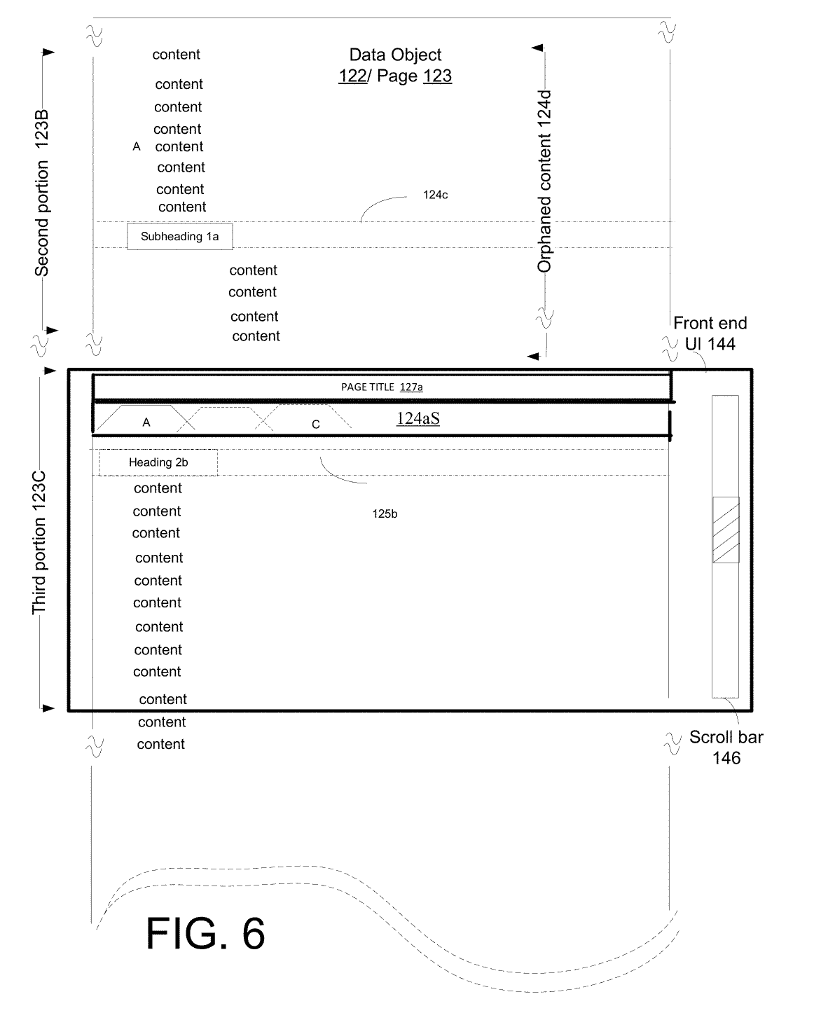

FIG. 6 schematically shows, for example, an instance where all of orphaned content 124d been scrolled out of view in display window 148, and rendering engine 142 has released the associated snapping content header component (e.g., snapped-in content header component 124bS) so that it is no longer in view in display window 148, in accordance with the principles of the present disclosure. It may be noted that in the “release” example shown in FIG. 6, snapped-in navigation links container 124aS remains in view in display window 148 so that the viewer can still navigate to different sections of data object 122/page 123.

In the foregoing example scenarios of FIGS. 2-6, only one of the content separators (e.g., content header component 124b) was described as having orphaned associated content in display window 148. However, other content separators (e.g., subheading component 124c, content header component 125c, etc.) when scrolled out of display window 148 can also leave behind corresponding orphaned associated content in the display window. In such cases, rendering engine 142 may, for example, snap more than one content separator as guide to the corresponding orphaned contents in view in display window 148.

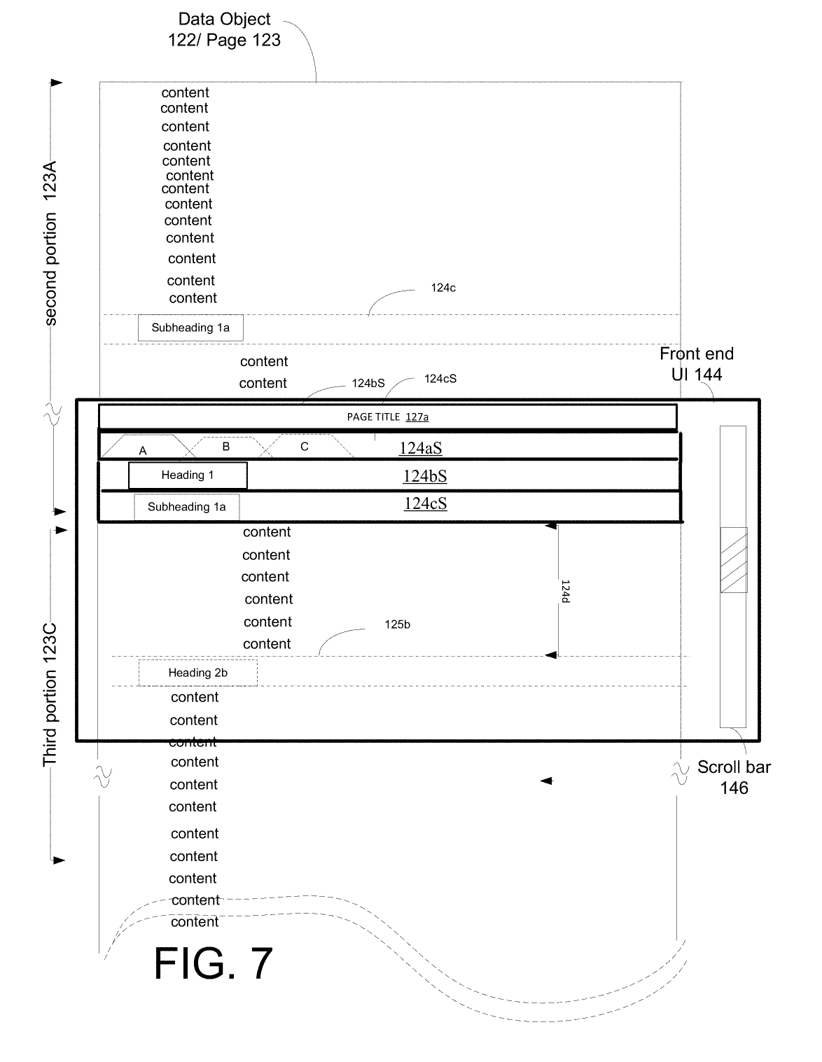

FIG. 7 shows an example in which two snappable content separators (e.g., snapped-in content header component 124bS and snapped-in subheading component 124cS corresponding to content header component 124b and subheading component 124c) have been snapped to respective target areas in display window 148 as guide to the orphaned content (e.g., orphaned content 124d) in view in display window 148, in accordance with the principles of the present disclosure. It is noted that the target area where subheading component 124cS is snapped in is just below the lowest snapped-in content separator (i.e., snapped-in content header component 124bS) that is in view in display window 148.

In example implementations, rendering engine 142 may include or be coupled to event listeners that can detect scrolling events (e.g. scroll start, and scroll stop) and other events (e.g. snap designation or registration of UI components, etc.). Rendering engine 142 may snap or release snapped in content headers in display window of UI 144 in response to the detected events. Rendering engine may, for example, snap or release a content header in display window 148 after an event of scroll stop.

In an example implementation, rendering engine 142 may be configured to provide a common UI (e.g., front end UI 144) for the multiple and diverse applications (e.g., computer application 140) under a unified UI framework designed to provide a common, same or unified user experience (UX) to the user when launching, accessing or interacting with computer application 140 from any type of computing devices (e.g., laptops, smartphones, desktop computers, etc.). The size of, and the UI elements included in, front end UI 144 displayed on a computing device may depend on the size of the display screen of the client computer device available for display.

In example implementations, rendering engine 142/UI 144 may be implemented, for example, on HTML5/CSS/JS technology platform using a SAPUI5 framework. Construction of rendering engine 142/UI 144 may adhere to a consistent, responsive design that allows users to seamlessly experience UI 144 across interaction channels—desktop, tablet, mobile, etc.

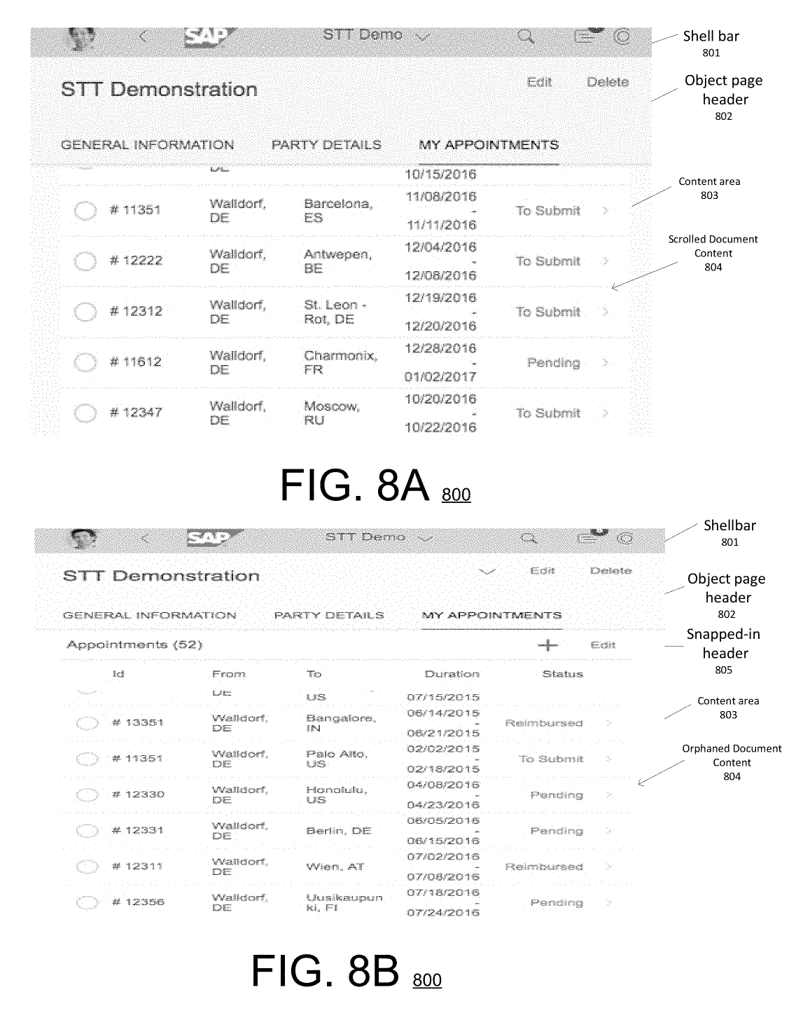

FIGS. 8A and 8B are screenshots of an example UI display window 800 illustrating use of snapped-in content headers by rendering engine 142 to guide viewers to orphaned document content when a viewer scrolls a document through the display window, in accordance with the principles of the present disclosure.

In the example shown in FIGS. 8A and 8B, UI display window 800 is used to display a page of a document that the viewer can scroll up or down through the display window. UI display window 800 may include a shell bar 801, an object page header 802 (e.g., page title 127a) and a content area 803 (e.g., page title 127a). Shell bar 801 and object page header 802 (like page title 127a) remain stationary in view even as the document is scrolled through content area 803. FIG. 8A shows an instance when the viewer has scrolled the displayed document to bring scrolled document content 804 in view in content area 803. Scrolled document content 804 may be orphaned content associated with a content header (e.g., content header 805) that may have been scrolled out of view when the viewer has scrolled the displayed document to bring scrolled document content 804 in to view in content area 803. FIG. 8B shows an instance (after the viewer has stopped scrolling) at which content header 805 has been snapped in to UI display window 800 in a target area below object page header 802. Snapped-in content header 805 may visually inform the viewer about scrolled document content 804 in view in content area 803.

A document (e.g., data object 122/page 123), which is rendered in a display window (e.g., display window 148/UI 144) by rendering engine 142, may include multiple hierarchical levels of document content. The multiple hierarchical levels of document content may correspond to a number of different levels of content separators (e.g., snappable content header components) that can be possibly snapped back into the display window by rendering engine 142 as the document is scrolled in the display window. In a scrolling scenario in which a large number of the different levels of the content separators are concurrently snapped into the display window (at corresponding target areas), the snapped-in content separators may consume a significant amount of the display area of the display window leaving little of the display area for actually displaying the document content. To avoid such situations and to keep a reasonable amount of the display area available for visually displaying the document content, in example implementations, a threshold or limit (e.g., 45% of screen height) may be set to limit the area that is available to display the snapped-in content separators. The threshold or limit may depend on the size of the display screen of the client computer device on which the document is rendered.

The snapped-in content separators may form a hierarchical stack (see e.g., hierarchical stack: snapped-in navigation links container 124aS/snapped-in content header component 124bS/snapped-in subheading component 124cS, FIG. 7) of content separators. As further snapped-in content separators are added to the hierarchical stack, the area consumed by the hierarchical stack may approach the threshold or limit (e.g., 45% of screen height) set to limit the area available to display the snapped-in content separators in the display window. However, depending on the state of the scrolled document content in the display window, rendering engine 142 may need to add additional snapped-in content separators to the hierarchical stack (e.g., at the bottom of the stack). In an example implementation, the additional snapped-in content separators may be accommodated within the area available in the display window to display the hierarchical stack, for example, by scrolling upper components of the hierarchical stack itself out of the display window to create open space at the bottom of the hierarchical stack for the additional snapped-in content separators. In some instances (e.g., on small-screen mobile devices), additionally or alternatively, more open space for receiving the additional snapped-in content separators may be created in the display window by overflowing the hierarchical stack of content separators to a summary line.

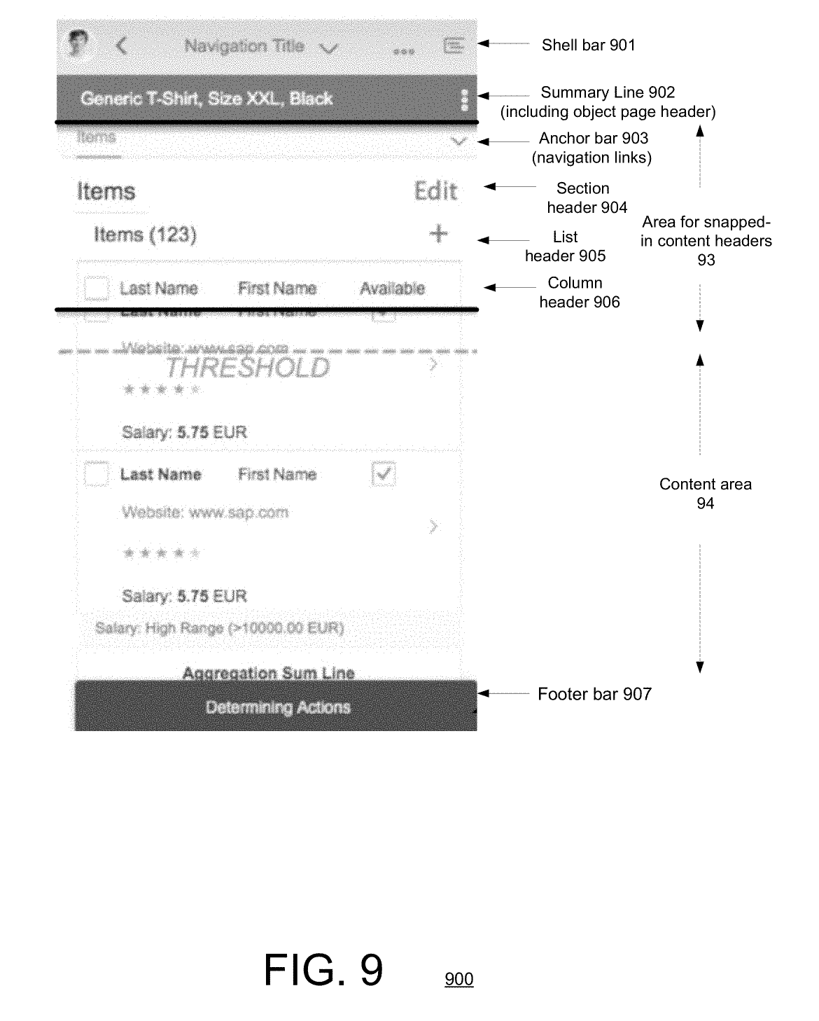

FIG. 9 is a screenshot of an example display window 900 that includes a summary line feature, in accordance with the principles of the present disclosure. Display window 900 may be displayed, for example, on a small size touch screen of a mobile device. A scrollable document may be rendered in display window 900, for example, by rendering engine 142. A threshold or limit 91 may be used to limit an area 93 that is available for snapped-in content separators and a content area 94 available to display document content in display window 900.

Example display window 900 may include a static shell bar 901, a summary line 902, and a static footer bar 907 that remain stationary as the rendered document is scrolled through display window (e.g., by finger touch-screen scrolling). Summary line 902 may, for example, include the object page header of a page displayed in display window 900. Rendering engine 142 may snap in content headers (e.g., anchor bar 903 (navigation links), section header 904, list header 905, and column header 906, etc.) in display window of UI 144 in response to detected scrolling events. Anchor bar (navigation links) may, for example, change to a dropdown (arrow on the right) in a phone mode (or if the window gets narrow).

In the scenario in which there are more snapped-in content headers than can be accommodated in area 93 (that is available for snapped-in content separators in display window 900), rendering engine 142 may contain the overflow of snapped-in content separators from area 93 in a summary line (e.g., summary line 902) in display window 900. A viewer may access the overflowed snapped-in content separators by expanding summary line 902 in display window 900.

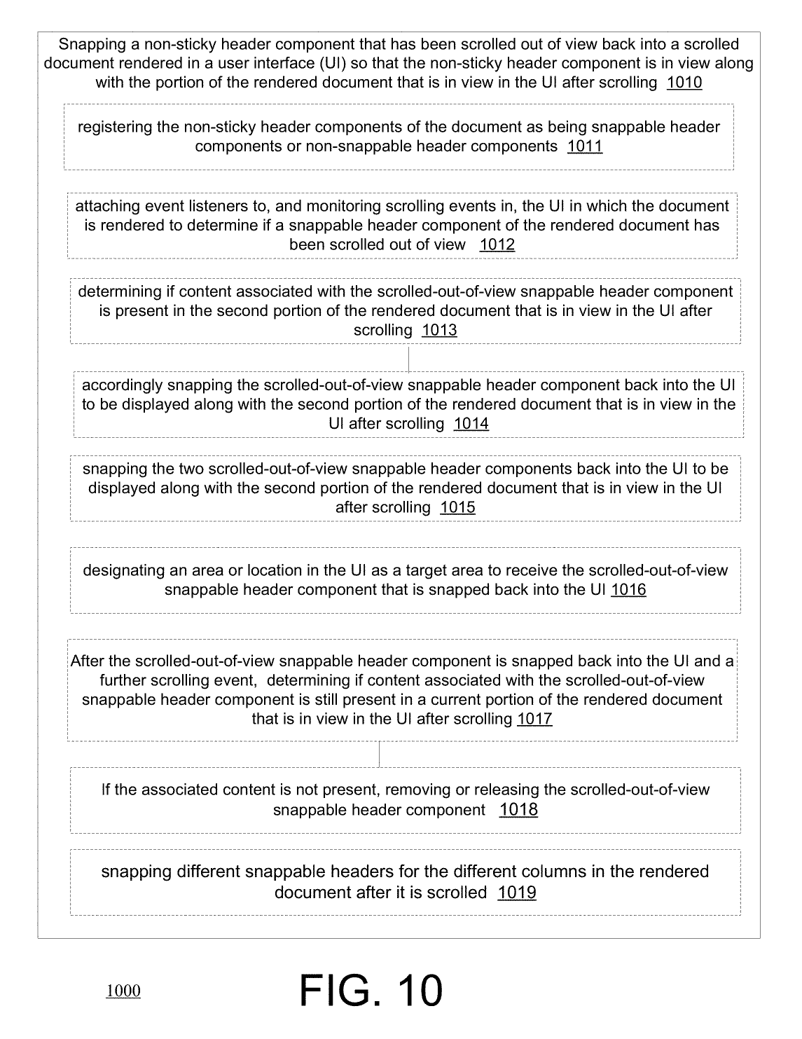

FIG. 10 shows an example method 1000 for rendering a data object (e.g. a document) in a user interface (UI) on a computing device, in accordance with the principles of the present disclosure. The data object (e.g. a document) may, for example, be rendered as a page in the user interface (UI) on the computing device. The UI on the computing device in which the document is rendered may, for example, be a scroll container. The rendered document may be scrolled through the scroll container, for example, by a viewer, using a scroll-enabling UI element or technique (e.g., a scroll bar, finger touch-screen scrolling, hold-and-drag operation, or page up/down buttons on a computer keyboard, etc.).

The document may contain controls or components (e.g., column headers, table toolbars, tab containers, navigation controls, etc.) (hereinafter “content header components”) that relate to, or are associated with, document content that may be displayed, for example, underneath the content header components in the rendered document. The content header components may serve as a guide to associated document content or provide actions. A content header component may be sticky header component or a non-sticky header component. A non-sticky header component may scroll out of view when a first portion of the document is scrolled out of the scroll container and thus is not available to the viewer for reference or for actions on a portion (e.g. a second portion) of the rendered document that may be in view after scrolling.

Method 1000 may include snapping a non-sticky content header component that has been scrolled out of view back into a scrolled document rendered in the UI so that the non-sticky content header component is in view along with the second portion of the rendered document that is in view in the UI after scrolling (1010).

Method 1000 may include registering the non-sticky content header components of the document as being snappable content header components or non-snappable content header components (1011). Method 1000 may include attaching event listeners to, and monitoring scrolling events in, the UI in which the document is rendered to determine if a snappable content header component of the rendered document has been scrolled out of view (1012). Monitoring scrolling events may include determining scrolling start events and scrolling stop events. Further, method 1000 may include determining if content associated with the scrolled-out-of-view snappable content header component is present in the second portion of the rendered document that is in view in the UI after scrolling (1013), and accordingly snapping the scrolled-out-of-view snappable content header component back into the UI to be displayed along with the second portion of the rendered document that is in view in the UI after scrolling (1014).

In some instances, the document may have different levels of content headers (e.g., content headers and sub-content headers). In such instances, content associated in common with two scrolled-out-of-view snappable content header components may be present in the second portion of the rendered document that is in view in the UI after scrolling. In such instances, method 1000 may include snapping the two scrolled-out-of-view snappable content header components back into the UI to be displayed along with the second portion of the rendered document that is in view in the UI after scrolling (1015).

Method 1000 may include designating an area or location in the UI as a target area to receive the scrolled-out-of-view snappable content header component that is snapped back into the UI (1016).

After the scrolled-out-of-view snappable content header component is snapped back into the UI and a further scrolling event, method 1000 may include determining if content associated with the scrolled-out-of-view snappable content header component is still present in a current portion of the rendered document that is in view in the UI after scrolling (1017). If the associated content is not present, method 1000 may include removing or releasing the scrolled-out-of-view snappable content header component (10110).

In some cases, the document may contain content that is extended over multiple columns and different columns may have different snappable and non-snappable content headers. In such cases, method 1000 may include snapping different snappable content headers for the different columns in the rendered document after it is scrolled (1019).

The techniques and methods (e.g., method 1000) for reintroducing scrolled-out-of-view content header components in a document may be implemented, for example, using rendering engine 142 of system 100 (FIG. 1)

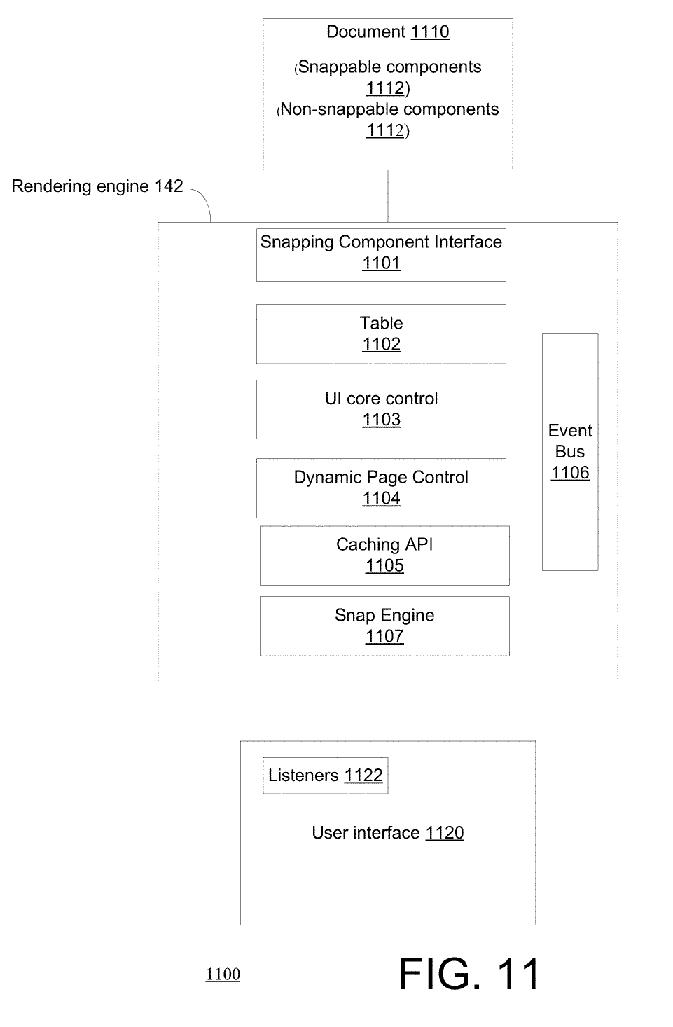

FIG. 11 shows an example structure of rendering engine 142 configured to display a data object on a user interface of a computing device and modify the display of the data object after the data object is scrolled up or down in the UI, in accordance with the principles of the present disclosure.

Rendering engine 142 may be constructed using, for example, UI-related JavaScript functionality. An example implementation of rendering engine 142 may be based on SAP's Dynamic Page class implementation of a UI that is sub classed to build a Snap-enabled Dynamic Page UI. A Dynamic Page can have multiple components. A component may be a snappable component or a not-snappable component. The Snap-enabled Dynamic Page implementation may enable all components contained in the page that have declared themselves as snappable to be considered for snapping to a pre-defined target geometry in the UI.

An example rendering engine 142 (as shown in FIG. 11) may include a Dynamic Page Control function 1104, a UI core Control function 1103, a Snapping Component Interface 1101, a Table 1102, a Caching API 1105, an event bus 1106 and a Snap Engine 1107. Rendering engine 142 may be hosted on the same computing device as UI 1120 or another connected computing device or computing platform. Document 1110 may include snappable components (e.g., snappable components 1112) and include non-snappable components (e.g. non-snappable components 1114).

Rendering engine 142 may be configured to render the data object (e.g., a document 1110) on a user interface (e.g., UI 1120) of a computing device as a web page (e.g., a Dynamic Page). Dynamic Page Control 1104 may include a layout control, representing a generic web page (e.g., Dynamic Page), consisting, for example, of a page title, a content area, and one or more content headers with dynamic behavior, etc. A generic layout control implementation may be extended to create a “Dynamic Page Snappable” object using a Snap Engine object created by Snap Engine 1107. The Snap Engine object may be created just before the Dynamic Page Snappable object is rendered on UI 1120. After rendering the Dynamic Page Snappable object, rendering engine 142 may register Snap Engine 1107 for callbacks on Scroll events recognized on event bus 1106.

In rendering engine 142, Table 1102 may provide an interface (e.g., Snapping Component Interface 1101) where document 1110 may register the individual snappable components of the document. Table 1102 may subclass a Table object class and register a table header as a snappable component on rendering. Table 1102 may publish registration (and changes in registration) of snappable components of the document on an event bus (event bus 1106).

Caching API 1105 may be configured to store a list of components that have registered themselves as snappable. The list can be used (e.g., by Snap Engine 1107) at a later time to identify components that need to be snapped into a target area (e.g., Title) in the rendered Dynamic Page Snappable object.

Snap Engine 1107 when created may store a root level UI component that it is created for (i.e., the Dynamic Page Snappable object). Snap Engine 1107 may also store a snap target area (e.g., Title) in the Dynamic Page Snappable object that is available for components to be snapped into. Snap Engine 1107 may be configured to listen on event bus 1106 to see if any component that is a child of the root UI component is registered as being snappable (e.g., via Snapping Component Interface 1101 and Table 1102).

Snap Engine 1107 may use Caching API 1105 to remember the components that have registered themselves as being snappable components (e.g., via Snapping Component Interface 1101 and Table 1102).

Rendering engine 142/Snap Engine 1107 may be configured to deploy or utilize event listeners 1122 on UI 1120 (e.g., a scroll container) to listen for scrolling events (“Scroll events”) related to the Dynamic Page rendered in UI 1120. Rendering engine 142/Snap Engine 1107 may be configured to recognize when a non-sticky control or component in the rendered document is scrolled out of view on UI 1120 of the computing device, and if the non-sticky control or component happens to be a snappable component, snap the non-sticky component back into view on UI 1120 as may be needed.

Rendering engine 142/Snap Engine 1107 may, for example, be configured to implement callbacks for scroll events. When a user scrolls, the scrolled Dynamic Page will newly render in UI 1120, but the callbacks for the scroll events will enable Snap Engine 1107 to snap the snappable components back into the Snap target (e.g. Title) of the scrolled Dynamic Page.

Example snippets of javascript code (e.g., DynamicPageSnapEnabled.js, SnapEngine.js, TableSnapEnabled.js, and CachingAPI.js) that may be used to implement components of rendering engine 142 are shown below.

DynamicPageSnapEnabled.js

| | |
|---|---|
| 1 | |
| 2 | sap.ui.define([‘sap/f/DynamicPage’, |

‘sap/ux/proto/app/core/SnapEngine’], function (DynamicPage, SnapEngine)
{

| | |
|---|---|
| 3 | “use strict”; |

4

| | |
|---|---|
| 5 | var DynamicPageSnapEnabled = Dynam- |

icPage.extend(“sap.ux.proto.app.controls.DynamicPageSnapEnabled”, {
6

| | |
|---|---|
| 7 | metadata: { |

| | |
|---|---|
| 8 | properties: { |

| | |
|---|---|
| 9 | enableSnapping: {type: “boolean”, default: true} |

| | |
|---|---|
| 10 | } |

| | |
|---|---|
| 11 | }, |

12

| | |
|---|---|
| 13 | onBeforeRendering: function ( ) { |

| | |
|---|---|
| 14 | // Takes care about snapping |
| 15 | this._snapToTop = new SnapEngine({ |

| | |
|---|---|
| 16 | rootcomponent: this, |
| 17 | snapTarget: this.getTitle( ) |

| | |
|---|---|
| 18 | }); |

| | |
|---|---|
| 19 | }, |

20

| | |
|---|---|
| 21 | onAfterRendering: function ( ) { |

| | |
|---|---|
| 22 | // Root can't be used here |
| 23 | let $scrollContainer = |

$(this.getDomRef( )).find(“.sapFDynamicPageContentWrapper”);

| | |
|---|---|
| 24 | $scrollContainer.on(“scrollstart”, ( ) => |

this._snapToTop.release( ));

| | |
|---|---|
| 25 | $scrollContainer.on(“scrollstop”, ( ) => |

this._snapToTop.snap( ));

| | |
|---|---|
| 26 | }, |

27
28

| | |
|---|---|
| 29 | renderer: { |

| | |
|---|---|
| 30 | render: function (renderManager, oControl) { |

| | |
|---|---|
| 31 | sap.f.DynamicPageRenderer.render(renderManager, |

oControl);

| | |
|---|---|
| 32 | } |

| | |
|---|---|
| 33 | } |

| | |
|---|---|
| 34 | }), |

35

| | |
|---|---|
| 36 | return DynamicPageSnapEnabled; |

| | |
|---|---|
| 37 | }); |
| 38 | |

SnapEngine.js

```
  1.
  2. sap.ui.define([′sap/ux/proto/app/core/CachingAPI′], function (Cach-
ingAPI) {
```

″use strict″;

3.

| | |
|---|---|
| 4. | class SnapEngine { |

5.

| | |
|---|---|
| 6. | constructor(oArgs) { |

| | |
|---|---|
| 7. | if (oArgs.rootComponent && oArgs.snapTarget) { |

8.

| | |
|---|---|
| 9. | this._rootComponent = oArgs.rootComponent; |
| 10. | this._snapTarget = oArgs.snapTarget; |
| 11. | this._cache = new CachingAPI( ); |

12.

| | |
|---|---|
| 13. | this.initListeners( ); |

14.

| | |
|---|---|
| 15. | } else { |

| | |
|---|---|
| 16. | throw Error(″Root component or snapping target is |

not defined″);

| | |
|---|---|
| 17. | } |

| | |
|---|---|
| 18. | } |

19.

| | |
|---|---|
| 20. | /** |
| 21. | * Helper function to check if the specific component is |
| 22. | * child of root node |
| 23. | * |
| 24. | * @param oComponent |
| 25. | * @returns {boolean} |
| 26. | */ |
| 27. | isChildOfRoot(oComponent) { |

| | |
|---|---|
| 28. | while (oComponent && oComponent.getParent) { |

| | |
|---|---|
| 29. | oComponent = oComponent.getParent( ); |
| 30. | if (oComponent === this._rootComponent) { |

| | |
|---|---|
| 31. | return true; |

| | |
|---|---|
| 32. | } |

| | |
|---|---|
| 33. | } |

| | |
|---|---|
| 34. | } |

35.

| | |
|---|---|
| 36. | /** |
| 37. | * @hint This workaround is required because components |

can be embedded inside

| | |
|---|---|
| 38. | * other components, therefore it's not possible to ini- |

tialize

| | |
|---|---|
| 39. | * snapping with an array of components |
| 40. | */ |
| 41. | initListeners( ) { |

| | |
|---|---|
| 42. | let oEventBus = sap.ui.getCore( ).getEventBus( ); |

43.

| | |
|---|---|
| 44. | oEventBus.subscribe(″UIComponent″, ″CanSnap″, (sChan- |

nel, sEvent, oData) => {
45.

| | |
|---|---|
| 46. | if (sEvent === ″CanSnap″ && |

this.isChildOfRoot(oData.parent)) {

| | |
|---|---|
| 47. | this._cache.add({ |

| | |
|---|---|
| 48. | parent: oData.parent, |
| 49. | component: oData.component |

| | |
|---|---|
| 50. | }); |

| | |
|---|---|
| 51. | } |

| | |
|---|---|
| 52. | }, this); |

| | |
|---|---|
| 53. | } |

54.

| | |
|---|---|
| 55. | hasSnapEnabledComponents( ) { |

| | |
|---|---|
| 56. | return this._cache.get( ).length > 0; |

| | |
|---|---|
| 57. | } |

58.

| | |
|---|---|
| 59. | getOffsetFromTop(oComponent) { |

| | |
|---|---|
| 60. | let $oComponent = $(oComponent.getDomRef( )); |
| 61. | return Number($oComponent.offset( ).top + $oCompo- |

nent.height( ));

| | |
|---|---|
| 62. | } |

63.

| | |
|---|---|
| 64. | snap( ) { |

| | |
|---|---|
| 65. | let aSnapEnabledComponents = this._cache.get( ), |

| | |
|---|---|
| 66. | nOffsetFromTop = |

this.getOffsetFromTop(this._snapTarget),

| | |
|---|---|
| 67. | nThreshold = 0; |

68.

| | |
|---|---|
| 69. | for (let index = 0, max = aSnapEnabledCompo- |

nents.length; index < max; index++) {

| | |
|---|---|
| 70. | let $domRef = $(aSnapEnabledCompo- |

nents[index][″component″].getDomRef( ));

| | |
|---|---|
| 71. | let $domRefParent = $(aSnapEnabledCompo- |

nents[index][″parent″].getDomRef( ));

| | |
|---|---|
| 72. | let offset = $domRef.offset( ).top; |
| 73 | let offsetParent = $domRefParent.offset( ).top; |

74.

| | |
|---|---|
| 75. | if (offset − $domRef.height( ) < 0) { |

| | |
|---|---|
| 76. | $domRef.css({″transform″: ‘translate3d(0, |

${offsetParent * −1 + nOffsetFromTop + nThreshold}px, 0)‘,});

| | |
|---|---|
| 77. | $domRef.addClass(″animation--on″); |

| | |
|---|---|
| 78. | } |

79.

| | |
|---|---|
| 80. | nThreshold += $domRef.height( ); |

| | |
|---|---|
| 81. | } |

| | |
|---|---|
| 82. | } |

83.

| | |
|---|---|
| 84. | release( ) { |

| | |
|---|---|
| 85. | let aSnapEnabledComponents = this._cache.get( ); |

86.

| | |
|---|---|
| 87. | for (let index = 0, max = aSnapEnabledCompo- |

nents.length; index < max; index++) {

| | |
|---|---|
| 88. | let $domRef = $(aSnapEnabledCompo- |

nents[index][″component″].getDomRef( ));

| | |
|---|---|
| 89. | $domRef.removeclass(″animation--on″); |
| 90. | $domRef.css({″transform″: ″translate3d(0, 0, |

0)″});

| | |
|---|---|
| 91. | } |

| | |
|---|---|
| 92. | } |

93.

| | |
|---|---|
| 94. | } |

95.

| | |
|---|---|
| 96. | return SnapEngine; |

| | |
|---|---|
| 97. | |
| 98. | }); |
| 99. | |
| 100. | |
| 101. | |

TableSnapEnabled.js

```
  1
  2 sap.ui.define([‘sap/m/Table’], function (Table) {
```

| | “use strict”; |
|---|---|
| 3 | |
| 4 | var TableSnapEnabled = Ta- |

ble.extend(“sap.ux.proto.app.controls.TableSnapEnabled”, {
5

| | |
|---|---|
| 6 | metadata: { |
| 7 | properties: { |

| | |
|---|---|
| 8 | canSnap: {type: “boolean”, defaultvalue: true} |

| | |
|---|---|
| 9 | } |
| 10 | }, |

11
12

| | |
|---|---|
| 13 | notifyOnCanSnapChange: function ( ) { |
| 14 | let oEventBus = sap.ui.getCore( ).getEventBus( ); |
| 15 | oEventBus.publish(“UIComponent”, “CanSnap”, { |

| | |
|---|---|
| 16 | parent: this, |
| 17 | component: this.getHeaderToolbar( ), |

| | |
|---|---|
| 18 | }); |
| 19 | }, |

20

| | |
|---|---|
| 21 | onAfterRendering: function ( ) { |
| 22 | this.notifyOnCanSnapChange( ); |
| 23 | }, |

24

| | |
|---|---|
| 25 | /** |
| 26 | * Check if the component which tries to snap, is nested |

into this component.

| | |
|---|---|
| 27 | * Should be moved to the core |
| 28 | * |
| 29 | * @hint should be moved to control component proto for |

reuse in each component

| | |
|---|---|
| 30 | * @param oComponent |
| 31 | * @returns {boolean} |
| 32 | */ |
| 33 | isNestedInside: function (oParentComponent) { |
| 34 | let oComponent = this; |
| 35 | while (oComponent && oComponent.getParent) { |

| | |
|---|---|
| 36 | oComponent = oComponent.getParent( ); |
| 37 | if (oComponent === oParentComponent) { |
| 38 | return true; |
| 39 | } |

| | |
|---|---|
| 40 | } |
| 41 | }, |

42

| | |
|---|---|
| 43 | renderer: { |
| 44 | render: function (renderManager, oControl) { |

| | |
|---|---|
| 45 | sap.m.TableRenderer.render(renderManager, oCon- |

trol);

| | |
|---|---|
| 46 | } |
| 47 | } |

| | |
|---|---|
| 48 | }); |
| 49 | |
| 50 | return TableSnapEnabled; |
| 51 | }); |

CachingAPI.js

| | |
|---|---|
| 1 | |
| 2 | class CachingAPI { |
| | /** |

| | |
|---|---|
| 3 | * Initialization of caching API. |
| 4 | * |
| 5 | * @param {Array\|*} data : API can be initialized with an ar- |

ray or other data types

| | |
|---|---|
| 6 | */ |
| 7 | constructor(data) { |

| | |
|---|---|
| 8 | this._cache = [ ]; |
| 9 | if (data) { |

| | |
|---|---|
| 10 | this.add(data); |

| | |
|---|---|
| 11 | } |

| | |
|---|---|
| 12 | } |

13

| | |
|---|---|
| 14 | get( ) { |

| | |
|---|---|
| 15 | return this._cache; |

| | |
|---|---|
| 16 | } |

17

| | |
|---|---|
| 18 | isCached(data) { |

| | |
|---|---|
| 19 | for (let count = 0, max = this._cache.length; count < max; |

count++) {

| | |
|---|---|
| 20 | if (this._cache[count] === data) { |

| | |
|---|---|
| 21 | return true; |

| | |
|---|---|
| 22 | } |

| | |
|---|---|
| 23 | } |

| | |
|---|---|
| 24 | } |

25

| | |
|---|---|
| 26 | /** |
| 27 | * Adding data to cache |
| 28 | * |
| 29 | * @param {Array\|*} data : Arrays and other types of data can |

be added to the cache

| | |
|---|---|
| 30 | */ |
| 31 | add(data) { |

| | |
|---|---|
| 32 | if (!this.isCached(data)) { |

| | |
|---|---|
| 33 | if (Array.isArray(data)) { |

| | |
|---|---|
| 34 | this._cache = this._cache.concat(data); |

| | |
|---|---|
| 35 | } else { |

| | |
|---|---|
| 36 | this._cache.push(data); |

| | |
|---|---|
| 37 | } |

| | |
|---|---|
| 38 | } |

39

| | |
|---|---|
| 40 | return this._cache; |

| | |
|---|---|
| 41 | } |

42

| | |
|---|---|
| 43 | remove(data) { |

| | |
|---|---|
| 44 | let index = this._cache.indexOf(data); |
| 45 | if (index !== −1) { |

| | |
|---|---|
| 46 | this._cache.splice(index, 1); |

| | |
|---|---|
| 47 | } |
| 48 | return this._cache; |

| | |
|---|---|
| 49 | } |

50

| | |
|---|---|
| 51 | /** |
| 52 | * Removes all data from the cache. |
| 53 | */ |
| 54 | truncate( ) { |

| | |
|---|---|
| 55 | this._cache = [ ]; |
| 56 | return this._cache; |

| | |
|---|---|
| 57 | } |

| | |
|---|---|
| 58 | } |
| 59 | |
| 60 | // TODO: Fix issue with globals in mocha to allow testing |
| 61 | |
| 62 | // module.exports = CachingAPI; |
| 63 | sap.ui.define(function ( ) { |

| | |
|---|---|
| 64 | “use strict”; |
| 65 | return CachingAPI; |

| | |
|---|---|
| 66 | }); |

The various systems and techniques described herein may be implemented in digital electronic circuitry, or in computer hardware, firmware, software, or in combinations of them. The various techniques may implemented as a computer program product, i.e., a computer program tangibly embodied in an information carrier, e.g., in a machine readable non-transitory storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

What is claimed is:

1. A method comprising:
rendering a document as a page in a scroll container in a user interface (UI) on a computing device, the document containing one or more content header components associated with respective document contents, the rendered document being scrollable through the scroll container, at least one content header component being scrolled out of view in the scroll container when a first portion of the document is scrolled out of the scroll container bringing a second portion of the rendered document in view in the scroll container after scrolling; and
snapping the one content header component that has been scrolled out of view back into the scroll container so that the one content header component is in view along with second portion of the rendered document that is in view in the UI after scrolling.

2. The method of claim 1 further comprising registering the one or more content header components contained in the document as being snappable content header components or non-snappable content header components.

3. The method of claim 2 further comprising attaching event listeners to, and monitoring scrolling events in, the scroll container in which the document is rendered to determine if a snappable content header component of the rendered document has been scrolled out of view.

4. The method of claim 3, wherein monitoring scrolling events includes determining scrolling start events and scrolling stop events.

5. The method of claim 3, wherein monitoring scrolling events includes determining whether content associated with the scrolled-out-of-view snappable content header component is present in the second portion of the rendered document that is in view in the scroll container after scrolling.

6. The method of claim 5, wherein when content associated with the scrolled-out-of-view snappable content header component is present in the second portion of the rendered document that is in view in the scroll container after scrolling, snapping the scrolled-out-of-view snappable content header component back into the scroll container to be displayed along with the second portion of the rendered document that is in view in the scroll container after scrolling.

7. The method of claim 5, wherein the document has different levels of content header components and wherein content associated in common with two scrolled-out-of-view snappable content header components is present in the second portion of the rendered document that is in view in the scroll container after scrolling, snapping the two scrolled-out-of-view snappable content header components back into the scroll container to be displayed along with the second portion of the rendered document that is in view in the scroll container after scrolling.

8. The method of claim 5, wherein snapping the scrolled-out-of-view snappable content header component back into the scroll container to be displayed along with the second portion of the rendered document that is in view in the scroll container after scrolling includes designating a location in the scroll container as a target area to receive the scrolled-out-of-view snappable content header component that is snapped back.

9. The method of claim 5 further comprising, after the scrolled-out-of-view snappable content header component is snapped back into scroll container and a further scrolling event, determining whether content associated with the scrolled-out-of-view snappable content header component is still present in a current portion of the rendered document that is in view in the scroll container after the further scrolling event.

10. The method of claim 9 further comprising, when content associated with the scrolled-out-of-view snappable content header component is not present in the current portion of the rendered document that is in view in the scroll container after the further scrolling event, removing or releasing the scrolled-out-of-view snappable content header component from the scroll container.

11. A system comprising:
a processor; and
a memory, the processor executing instructions stored in the memory to create a rendering engine that:
renders a document as a page in a scroll container in a user interface (UI) on a computing device, the document containing one or more content header components associated with respective document contents, the rendered document being scrollable through the scroll container, at least one content header component being scrolled out of view in the scroll container when a first portion of the document is scrolled out of the scroll container bringing a second portion of the rendered document in view in the scroll container after scrolling; and
snaps the one content header component that has been scrolled out of view back into the scroll container so that the one content header component is in view along with second portion of the rendered document that is in view in the UI after scrolling.

12. The system of claim 11, wherein the rendering engine include an interface forth one or more content header components contained in the document to register as being snappable content header components or non-snappable content header components.

13. The system of claim 12 further comprising: event listeners attached to, and monitoring scrolling events in, the scroll container in which the document is rendered, to determine if a snappable content header component of the rendered document has been scrolled out of view.

14. The system of claim 13, wherein monitoring scrolling events includes determining scrolling start events and scrolling stop events.

15. The system of claim 13, wherein monitoring scrolling events includes determining whether content associated with the scrolled-out-of-view snappable content header component is present in the second portion of the rendered document that is in view in the scroll container after scrolling.

16. The system of claim 15, wherein when content associated with the scrolled-out-of-view snappable content header component is present in the second portion of the rendered document that is in view in the scroll container after scrolling, the rendering engine snaps the scrolled-out-of-view snappable content header component back into the scroll container to be displayed along with the second portion of the rendered document that is in view in the scroll container after scrolling.

17. The system of claim 16, wherein the rendering engine snaps the scrolled-out-of-view snappable content header component back into the scroll container at a target area designated to receive the scrolled-out-of-view snappable content header component that is snapped back.

18. The system of claim 17, wherein the document has different levels of content header components, wherein content associated in common with two scrolled-out-of-view snappable content header components is present in the second portion of the rendered document that is in view in the scroll container after scrolling, and wherein the rendering engine snaps the two scrolled-out-of-view snappable content header components back into the scroll container to be displayed along with the second portion of the rendered document that is in view in the scroll container after scrolling.

19. The system of claim 16, wherein after the scrolled-out-of-view snappable content header component is snapped back into scroll container and a further scrolling event, the rendering engine determine whether content associated with the scrolled-out-of-view snappable content header component is still present in a current portion of the rendered document that is in view in the scroll container after the further scrolling event.

20. The system of claim 16, wherein, when content associated with the scrolled-out-of-view snappable content header component is not present in a current portion of the rendered document that is in view in the scroll container after the further scrolling event, the rendering engine removes or release the scrolled-out-of-view snappable content header component from the scroll container.
